(19) United States
(12) Patent Application Publication
(10) Pub. No.: US 2025/0111433 A1
(43) Pub. Date: Apr. 3, 2025

(54) PORTABLE FINANCIAL DISPLAY DEVICE

(71) Applicant: Tom Youngworth, Hingham, MA (US)

(72) Inventor: Tom Youngworth, Hingham, MA (US)

(21) Appl. No.: 18/905,402

(22) Filed: Oct. 3, 2024

Related U.S. Application Data
(60) Provisional application No. 63/542,203, filed on Oct. 3, 2023.

(51) Int. Cl. G06Q 40/04; G06F 1/16

(52) U.S. Cl. CPC G06Q 40/04; G06F 1/1633

(57) ABSTRACT

A egg-shaped device that displays real-time stock market data, bond data, currency conversion rate data and other such financially pertinent information, as well as displaying a user's personal financial portfolio. The system includes a bottom casing with interchangeable designs and male threads, and a top casing comprising a server and a screen. The bottom casing is interchangeable in accordance with the user's preference. The top casing incorporates a server with a processor, main memory, and read-only memory. An operator, such as an application with executory software, sends stock market data and portfolio information to the server. The system includes differing sizes including handheld as well as deck top and table top versions. The display system employs a screen with multiple light emitters that illuminate based on information from the server, providing a visual representation of the data.

### CROSS REFERENCE TO RELATED APPLICATION

This application is a Utility Application which claims the benefit of and takes priority from U.S. Provisional Patent Application Ser. No. 63/542,203 filed on Oct. 3, 2023, from which priority is claimed under all applicable sections of Title 35 of the United States Code including, but not limited to, Sections 120, 363, and 365 (c).

### FIELD OF THE INVENTION

The present disclosure relates generally to communications systems, methods and devices, and portable financial devices. More particularly, exemplary embodiments of the invention concern systems and methods directed to transmitting data to a device capable of displaying data, particularly, stock market data, bond date, currency conversion data, as well as a user's personal financial portfolio in real time. Further illustrated is an egg-shaped device, embodiments of which range from small enough to fit in a user's pocket or purse to a larger decorative display for a desk or table. All embodiments feature a screen to display a plurality of data.

### BACKGROUND

The stock market is a dynamic and complex environment where investors and traders strive to make informed decisions based on various factors such as market trends, stock performance, and relevant news. Traditionally, individuals interested in tracking stock market activities have relied on computer-based applications, websites, or mobile applications that provide stock market information. While these tools have been helpful, they often present data in a dense and a overwhelming manner, making it challenging for users to quickly interpret and act upon the information.

Brokers and individuals as well are always looking for ways to view the stock market when they are on the move. A viewing device that addresses the limitations of existing tools by offering an innovative and user-friendly interface for comprehending and analyzing stock market data.

Such a device may also be intentionally designed with an aesthetic to greatly enhance the user experience by providing real-time, visually interesting, and customizable representations of stock market information, bond information, as well as individual portfolio information enabling users to engage in the stock market quickly and easily.

### SUMMARY OF THE INVENTION

The instant apparatus and system, as illustrated herein, is clearly not anticipated, rendered obvious, or even present in any of the prior art mechanisms, either alone or in any combination thereof.

It is an object of the present system to provide an egg-shaped decorative device which provides a display for viewing stock market data, bond data, conversion rate data and other such financially pertinent information, as well as displaying a user's personal financial portfolio.

It is additionally an object of the present system to provide an embodiment wherein, the egg-shaped decorative device, deemed the Nest Egg™ may contain an interchangeable bottom portion and a system for display of all data located on the top portion.

In one embodiment, the egg-shaped decorative device is an egg-shaped, handheld device, which exhibits pocket carrying compatible size and characteristics and provides a display for viewing stock market data, bond data, conversion rate data and other such financially pertinent information.

In one embodiment, the egg-shaped decorative device is a larger egg-shaped device which is configured to sit on top of a desk or table and provides a display for viewing stock market data, bond data, conversion rate data and other such financially pertinent information.

In one embodiment, the bottom portion may contain male threads which dynamically thread to the top portion which would natural corresponding female threads configured to accept the bottom half. The bottom half or portion may contain a hollow and interchangeable decorative section which may be replaced with the design of the user's liking. The top half or portion houses a server and is comprised of a screen which displays stock market data, bond data, conversion rate data and other such financially pertinent information, as well as a user's personal stock financial portfolio data.

It is a further objective to provide a system wherein the display system defines a screen with a plurality of light emitting pixels which light up based on information received from a server to a plurality of light controllers.

Furthermore, it is an objective of the system to provide a server which contains an input device or system which receives information and instructions from an operator mechanism. The operator may be configured with an application containing executory software configured to send stock market data, bond data, conversion rate data and other such financially pertinent information, as well as a user's personal stock financial portfolio data from the internet to be displayed on a screen.

In one embodiment, the server may include a processor which interprets and executes instructions received by the input from the operator and the server may also contain a main memory which has random access memory (RAM) or another equivalent dynamic storage mechanism which stores information and instructions to be executed by the processor.

The server further includes a read-only memory (ROM) or another equivalent static storage mechanism which stores information and instructions to be executed by the processor. Furthermore, the server includes an output which outputs information to the screen from the processor.

There has thus been outlined, rather broadly, the more important features of a portable sports rack and training apparatus and thus, the description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction, assembly and arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

### BRIEF DESCRIPTION OF THE DRAWINGS

The system may be more completely understood in consideration of the following detailed description of various embodiments of the system in connection with the accompanying drawings, in which:

FIG. 1 is a perspective view of the egg-shaped financial device according to the present disclosure.

FIG. 2 is front view of the bottom casing of the egg-shaped financial device according to the present disclosure.

FIG. 3 is a front view of the top casing of the egg-shaped financial device according to the present disclosure.

FIG. 4 is a diagram of the server in an implementation consistent with the egg-shaped financial device.

FIG. 5 is a diagram of the light emitting mechanism in an implementation consistent with the egg-shaped financial device.

FIG. 6 is a front perspective view of the egg-shaped financial device according to the present disclosure.

FIG. 7 is a rear perspective view of the egg-shaped financial device according to the present disclosure.

FIG. 8 is a right-side perspective view of the egg-shaped financial device according to the present disclosure.

FIG. 9 is a top plan view of the egg-shaped financial device according to the present disclosure.

FIGS. 10-11 are bottom views of the egg-shaped financial device according to the present disclosure.

While the system is amenable to various modifications and alternative forms, specifics thereof have been shown by way of example in the drawings and will be described in detail. It should be understood, however, that the intention is not to limit the system to the particular embodiments described. On the contrary, the intention is to cover all modifications, equivalents, and alternatives falling within the spirit and scope of the system.

### DETAILED DESCRIPTION

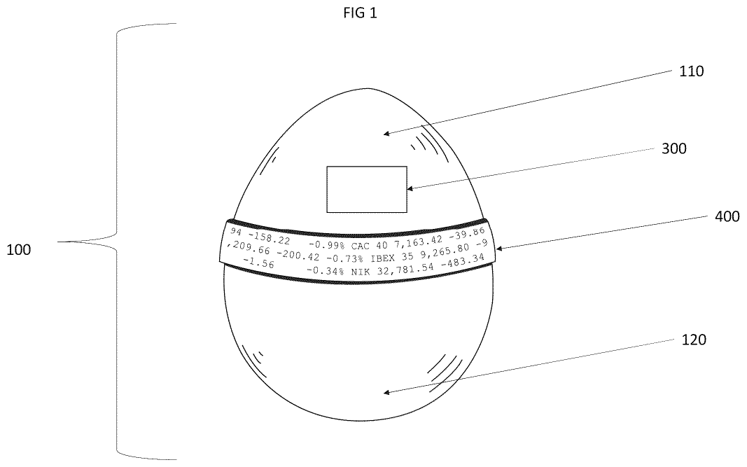

FIG. 1 is an exemplary embodiment of the egg-shaped financial device 100 as shown. The egg-shaped financial device 100 is comprised of a top casing 110 and a bottom casing 120. The bottom casing 120 is interchangeably attached to the top casing 110 via a threaded mechanism 200. The top casing 110 houses a server 300 and is further comprised of a screen 400. The screen 400 is preferably a band which wraps around the top casing 110. The screen 400 can be configured to numerous inches wide in order to provide the best viewing comfort.

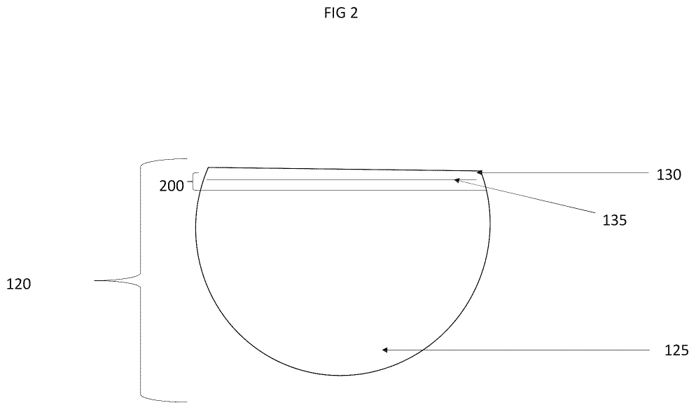

FIG. 2 is an exemplary embodiment of the bottom casing 120 of the egg-shaped financial device 100. The bottom casing 120 is comprised of a bottom portion 125 and a top portion 130. The top portion 125 is configured to dynamically attach to the top casing 110 via a threaded mechanism 200 and the top portion 130 further comprises a male threaded edge 135. The male threaded edge 135 dynamically threads to the top casing 110.

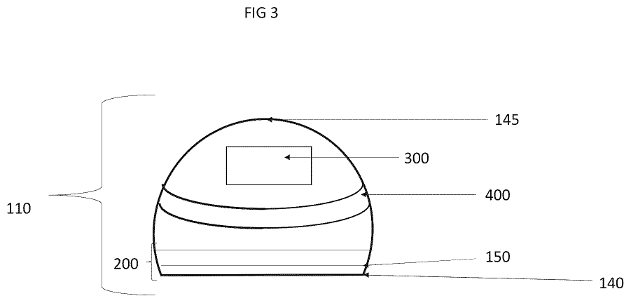

FIG. 3 is an exemplary embodiment of the top casing 110 of the egg-shaped financial device 100. The top casing is comprised of a bottom portion 140, a screen 400, the server 300, and a top portion 145. The bottom portion 140 is configured to dynamically attach to the top portion 130 of the bottom casing 120 via a threaded mechanism 200 and the bottom portion 140 further comprises a female threaded edge 150. The female threaded edge 150 is configured to dynamically receive the male threaded edge 135 of the bottom casing 120.

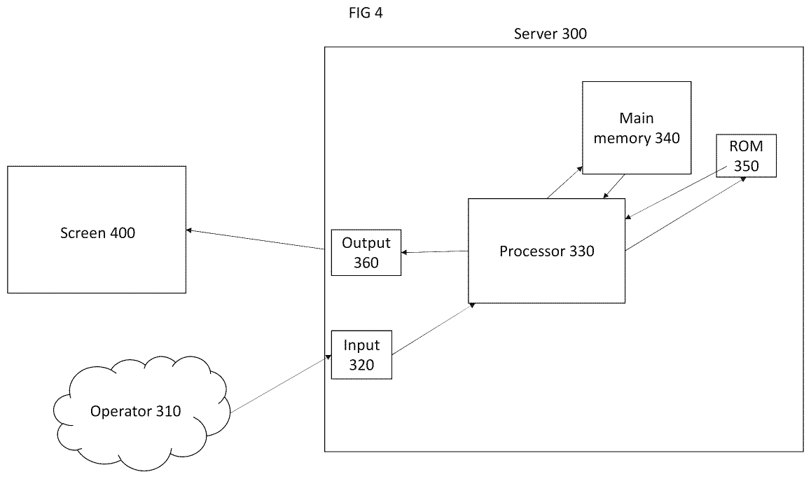

FIG. 4 is an exemplary diagram of the server 300 in an implementation consistent with the present invention. The server 300 is comprised of an input 320 configured to receive information and instructions from an operator 310, a processor 330 which interprets and executes instructions received by the input from the operator, a main memory 340 which stores information and instructions to be executed by the processor, a ROM 350 which stores information and instructions to be executed by the processor, and an output 360 configured to send information to a light emitting mechanism 410.

The operator 310 is configured with executory software which may transmit U.S. stock market data and a user's personal portfolio from the internet for display on the screen 400. The screen 400 is lit up by a plurality of light emitting pixels 430 configured to light up in accordance with information sent from the operator 310 to the server 200 and finally to the screen 400.

FIG. 5 is an exemplary diagram of the light emitting mechanism 410 consistent with the present invention. The screen 400 is preferably black and displays data as letters and numbers in different LED light colors, namely white, red, and green. The screen 400 is electrically connected to a light emitting mechanism 410 which is controlled by the server 300 which sends instructions to a plurality of light controllers 420 to light up light emitting pixels 430. The screen 400 is comprised of the plurality of light emitting pixels 430, the light emitting pixels 430 being capable of transmitting LED light. The pixels 430 of the screen are configured to light up as plurality of light controllers 420 are given instructions from the server 300.

FIG. 6 is a front perspective view of the egg-shaped financial device 100. FIG. 6 is a front perspective view of the egg-shaped financial device 100. FIG. 7 is a rear perspective view of the egg-shaped financial device 100.

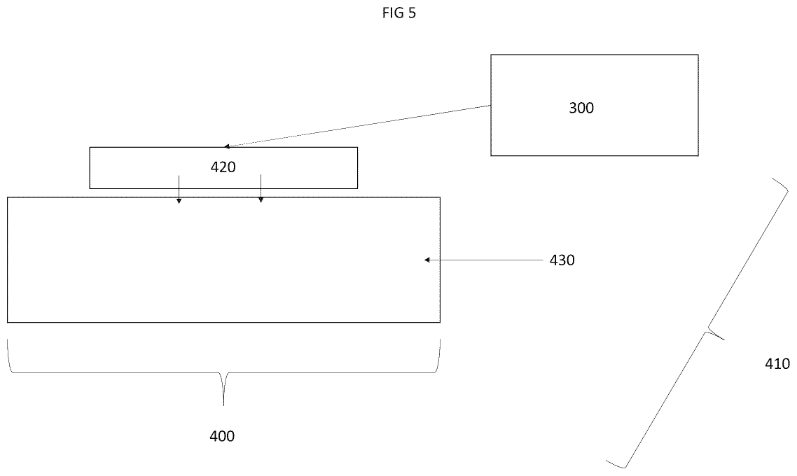

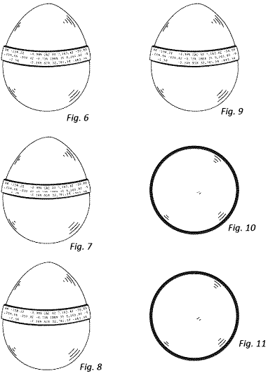

FIG. 8 is a right-side perspective view of the egg-shaped financial device 100. FIG. 9 is a top plan view of the egg-shaped financial device 100. FIGS. 10-11 are bottom views of the egg-shaped financial device 100.

What is claimed is:

1. An egg-shaped device for displaying financial data comprising:
a top casing configured to dynamically attach to a bottom casing with a threaded mechanism, and
a bottom casing configured to dynamically attach to a top casing with a threaded mechanism;
a screen configured to display stock market data with a light emitting mechanism, the light emitting mechanism comprising:
a plurality of light emitting pixels, and
a plurality of light controllers;
a server configured to store information and instructions.

2. The egg-shaped device for displaying stock market data of claim 1, wherein a threaded mechanism is configured to allow the bottom casing comprised of a male thread to dynamically attach to the top casing comprised of a female thread.

3. The egg-shaped device for displaying stock market data of claim 1, wherein the screen is electrically connected to the server, the server configured to emit instructions and information for the light emitting mechanism to light up the light emitting pixels by controlling the light controllers.

4. The egg-shaped device for displaying financial data of claim 1, wherein the server is comprised of:
an operator configured with executory software configured to send stock market data, bond data, currency conversion rate data and other such financially pertinent information, as well as displaying a user's personal financial portfolio to be displayed on a screen,
an input configured to receive information and instructions from the operator and send that to a processor,
a processor configured to interpret and execute instructions received by the input from the operator,
a main memory configured to store information and instructions to be executed by the processor,
a read-only memory configured to store information and instructions to be executed by the processor, and
an output configured to send information to the screen.

5. The egg-shaped device for displaying financial data of claim 1, wherein the light emitting pixels are comprised of LED lights, the LED lights being white, green and red lights.

6. The egg-shaped device for displaying financial data of claim 1, wherein the screen is preferably black.

7. The egg-shaped device for displaying financial data of claim 1, wherein the bottom casing is interchangeable according to the preference of a user.

8. The egg-shaped device for displaying financial data of claim 4, wherein the executory software of the operator is configured to retrieve stock market data, bond data, currency conversion rate data and other such financially pertinent information, as well a user's personal financial portfolio from the internet and configure it for display on the screen of the nest egg.

9. The egg-shaped device for displaying financial data of claim 4, wherein the main memory is a dynamic storage mechanism.

10. The egg-shaped device for displaying financial data of claim 4, wherein the read-only memory is a static storage mechanism.
